(19) United States
(12) Patent Application Publication
(10) Pub. No.: US 2007/0113062 A1
(43) Pub. Date: May 17, 2007

(54) Bootable computer system circumventing compromised instructions

(76) Inventors: Colin Osburn, Austin, TX (US); Kevin Garry, Austin, TX (US)

Correspondence Address: NATH & ASSOCIATES, PLLC;Sixth Floor, 1030 15th Street, N.W., Washington, DC, 20005, US

(21) Appl. No.: 11/273,605

(22) Filed: Nov. 15, 2005

(51) Int. Cl. G06F 15/177

(52) U.S. Cl. 713/1

(57) ABSTRACT

The inventive application includes a secondary OS for scanning which installs on one or many client computers and boots prior to a client's primary OS to counter security threats. In one configuration, a bootloader responds to a flagged condition to boot to the primary or secondary OS in accordance with the flagged condition. In another aspect, the secondary OS scans the file system of the primary OS to determine if remediation is required.

### FIELD OF THE INVENTION

This invention relates generally to computer bootloaders and computer security concerns. In particular, the invention relates to a system that provides operating system overrides integrated with a bootloader.

### BACKGROUND OF THE INVENTION

Computer security concerns include the computer being compromised by a security threat that cannot be properly countered while the computer is booted to its primary operating system (OS). Such threats involve different types of malware, viruses and other problems that affect the primary operating system and prevent normal operation of the computer through its operating system. In some cases, the problem cannot readily be remedied after the operating system is booted.

Computer operators do not generally have detailed knowledge of computer Operating System subsystems, networking components or pre-operating system commands. In prior art, these users commonly learn of security threats and solutions only at the primary OS level. As new security threats will continue to evolve, there is a need to install and operate computer security before the primary operating system loads.

As is known in the art, a computer application is a file or combination of files that are executable by an environment, or operating system (OS). Significantly, many computer security threats are executable applications. Such applications usually require a specific OS in which to execute; however it is possible that the malicious application is integrated with the OS and either prevents operation of the computer through the OS or prevents removal of the malicious application by use of antivirus or anti-malware software operating through the OS.

For the purposes of the description of this invention, “malicious application” is intended to describe any undesired function added to a computer that is not removable by normal operation of the computer. Examples include viruses, trojans, worms, spyware, scumware, unwanted adware, and other malware. In some instances the malware becomes integrated into the computer OS so that in order to operate the computer though the OS, the malware is loaded for execution. It is desired to be able to operate the computer without the execution of the malicious application.

In addition to malware, there are some functions or operations which, when performed, render a computer incapable of executing a self-repair function. This can be because the result of the function or operation is such that the computer's primary operating system is disabled to an extent that the computer is unable to boot, or the computer cannot perform functions essential to effecting a repair.

There is an intrinsic dilemma of relying upon a previously compromised computer to administer security counters upon itself. The description of, “administer security counters upon itself,” refers to a malicious application or problem which compromises the computer by compromising the administration functions necessary to detect and remove the malicious application. The compromised computers may have security applications installed on them, which cannot be relied upon to function correctly due to the computer's compromised state. A compromised computer's installed security applications, by nature, run in the OS of the computer, but as that OS is compromised, it is possible that a security threat, which also runs in the OS of the computer, could work against the OS in its attempt to counter the threat.

Bootloaders are a common technique to permit loading of an operating system on a computer. Bootloaders are typically addressed initially by BIOS, at a predefined address on a primary disk drive's partition, referred to as a master boot record, typically consisting of 512 bytes on a hard disk. By way of example, on PC computers intended to operate on MS DOS or Windows, boot loaders is in first 446 bytes of the master boot record. This leaves room for a partition table and a 2-byte AA55h ‘signature’.

In many cases, multi-stage bootloaders are used, in which the first bootloader points to a second or subsequent bootloader. This permits additional functions, such as disk address modifications for outsized disk drives, and various other boot-up procedures that would not fit in the allocated space. The first stage of boot loaders must fit into the first predefined address on the primary disk drive's partition, and subsequent bootloaders are addressed in sequence.

In the most common configuration, the bootloader automatically loads a single operating system, such as Microsoft DOS or Windows. In other cases, the bootloader is integrated into BIOS or provides additional functions such as loading disk mapping routines prior to launching the operating system. It is also common for bootloaders to load multiple operating systems, such as LILO and GRUB used to launch Linux or another operating system according to user choice.

A similar series of programs provide functions similar to bootloaders, except that they are able to launch a different OS from a given OS. These have the function of closing one OS and launching a second OS.

It is also known to provide for sharing of file systems between multiple operating systems. The primary requirement for file sharing is that the active OS be able to recognize and open files in. the particular file format. By way of example, Windows (except for some versions of Windows 95) can open files stored on volumes in either DOS, FAT32 and CD-ROM formats. While executable applications require some form of execution software such as middleware, data files need only be interpreted. Examples of files readable through multiple operating systems are files provided for Internet browsing normally launched by the user's Internet browser.

### SUMMARY OF THE INVENTION

According to the present invention, a computer is provided with a bootloader which permits removal of a malicious application by executing a malware detection and removal program prior to executing the computer's intended operating system. In particular, the invention relates to a system that provides operating system overrides integrated with a bootloader. The inventive application includes a secondary OS for scanning which installs on one or many client computers and boots prior to a client's primary OS to counter security threats.

The present invention addresses the issue of a previously compromised computer attempting to administer security counters upon itself. The invention solves this dilemma by allowing a client's security applications to run in an installed, secondary OS, or aspects of the client's applications to be utilized by an installed, secondary OS for scanning. The secondary OS for scanning is not integral with the primary OS and can be trusted not to be compromised and can fully access the entire file system.

For the purpose of this description, the “primary OS” is intended to mean any OS which is operated to perform the normal functions of the computer. In some cases, another program or bootloader may consider the particular OS to be other than “primary”; however that non-primary designation of the OS is not relevant to this invention. By way of example, if a bootloader can select two operating systems, designating one OS to be “primary” and the other “secondary”, either OS can be “primary” for the purposes of this invention.

It is conceivable that one of the operating systems loaded by a different bootloader is the same as a program used by the present invention to scan a different OS. For the purposes of this invention, the OS used to scan a different OS would be a “secondary” OS even if the different bootloader categorized that OS as “primary”.

When the inventive bootloader locates a security threat, it can either remove the threat from the media or convert the file or files which represent the threat into a non-executable format without necessarily changing the name or location of the file or files. The conversion has the effect of permitting easy removal of the threat or manipulation of the malicious software after launch of the Primary OS.

After the inventive bootloader completes its actions, it logs the findings and actions taken on both the primary and secondary media partitions. At the end of operations, the inventive bootloader will prompt the client's Primary OS to load through a boot loader or sequential Master Boot Record (MBR).

### BRIEF DESCRIPTION OF THE DRAWINGS

The features, nature, and advantages of the present invention will become more apparent from the detailed description set forth below when taken in conjunction with the drawings in which like reference characters identify corresponding items throughout and wherein:

FIG. 1 is a flow chart depicting the operation of the inventive bootloader.

FIG. 2 is a flow chart depicting the overall operation of the invention.

FIG. 3 is a flow chart depicting a response to a threat detected in accordance with the present invention.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Overview

According to the present invention, a routine is run prior to launching a computer's operating system (OS). The routine is used to inspect and take into account and manage security applications already installed on the computer.

Application Running Under Primary OS

An application running under the Primary OS can be used to determine if the Primary OS is able to counter a detected security threat or changes within Primary OS. If the inventive application determines the Primary OS cannot counter the detected security threat or change within Primary OS, the application optionally causes, prompts or allows the computer to reboot or parallel boot into a secondary OS for scanning and remediation of malware threats, etc.

Upon reboot, the inventive bootloader will load its OS before client's primary native OS is loaded, and proceeds in the manner described.

Inventive Application Installed

When installed, the inventive application will reclaim media storage space from local media storage on the client's computer or upon an auxiliary device and installs a secondary OS for scanning. On booting the computer, the inventive application performs a bootloader function by launching the secondary OS for scanning, executing a security scan of the computer file system, performing any other desired security procedures and then launching the Primary OS.

Master Definition File (MDF)

Given the security applications installed on the client computer, the inventive application will create a Master Definition File (MDF) of the threats to look for, based upon client's security application choices as defined by the user. The MDF consolidates and manages the definitions and updates of software security on a given client computer or set of computers before the Primary OS loads. The MDF is one or more files which are either the malware definitions used by a third party anti-malware program or a separate file rendered by the third party anti-malware program. There can be multiple MDF files, which may be used in association with multiple types of anti-maiware programs. Additionally, if multiple operating systems are present on the computer, there can be a MDF applicable to each operating system.

The inventive application then scans the file system of the Primary OS for operational changes and items contained in the Master Definition File. If a security threat is detected, a determination is made as to whether the security threat should be disabled prior to booting the Primary OS. If the security threat is to be disabled, the inventive application removes or converts important, corruptible files into a non-executable format before the computer's Primary OS loads. The inventive application may use the MDF to perform the scan. Alternatively, the inventive application may use the information contained in the MDF or derived from the MDF if the MDF is not is a format usable by the inventive application.

Copies of the file(s) associated with the security threat(s) which were disabled can be transferred from the computer system onto any removable media storage or to remote media storage or to the file system housing the secondary OS. This information can be extracted and copied back to a user in the case that the local copies of these files become compromised or lost.

Multiple Operating Systems

In addition to the secondary OS for scanning used by the present invention, it is contemplated that the user will have multiple operating systems for active use by the user. A separate bootloader may be used prior to launching the inventive bootloader, or may be launched by the inventive bootloader subsequent to the inventive bootloader performing its scan. Alternatively, the inventive bootloader may be used to selectively launch one of the user's operating systems in lieu of a separate bootloader.

All actions taken by the inventive application are stored on dedicated media space accessible from the boot sector and on native OS media space used by the Primary OS or by any other file system accessible to the computer. The inventive application calls the primary native OS to load by booting itself down. The boot loader will then load the primary native OS.

The primary operating system can be any operating system under which the computer operates, so that it is possible for an operating system defined as “secondary” for other purposes to perform the functions of a “primary” operating system for the purpose of the description of the present invention. Likewise, the inventive bootloader may be a secondary bootloader, and the computer's Primary OS may be launched by a subsequent bootloader.

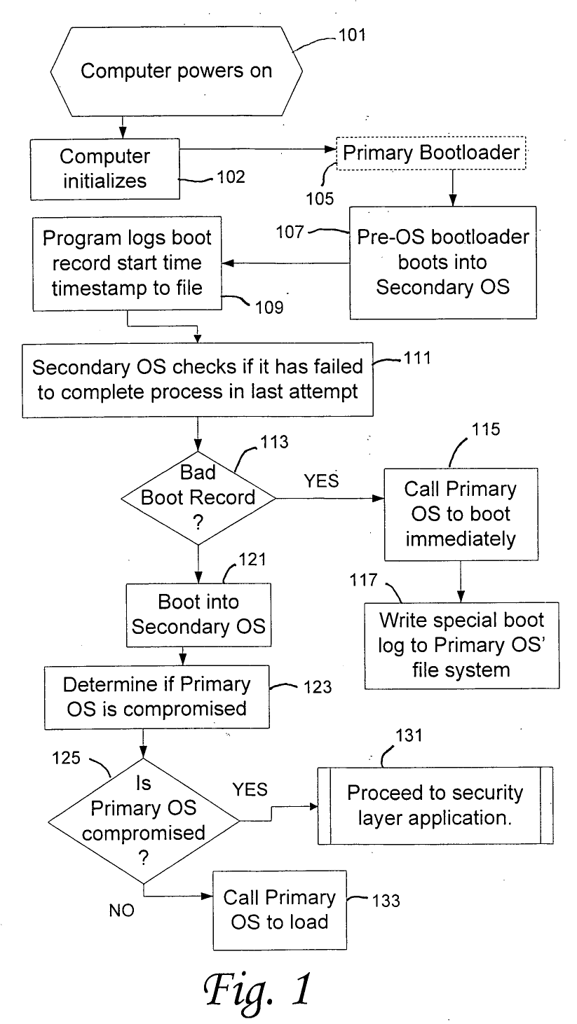

FIG. 1 is a flow chart depicting the operation of the inventive bootloader. As depicted, the pre-OS scanning function is launched after the computer powers on (step 101), followed by the normal computer initialization functions such as BIOS and POST tests implemented by BIOS (step 102), it being understood that the particular boot sequence of the computer varying according to the configuration of the computer. The inventive bootloader then boots through its primary bootloader, if any (step 105) that loads the pre-OS bootloader (step 107). The boot record is logged as a start timestamp to a file (step 109) by the Secondary OS.

In the case of a PC configured with a 512 byte master boot record (MBR), the use of primary bootloader (step 105) is implemented because of the primary bootloader is limited in function to no more than the 512 bytes (typically 446 bytes). Therefore, any substantial operating steps must be performed beyond the space allocated to the primary bootloader, and the inventive secondary bootloader is called (step 107). In this scenario, the invention is implemented through a multi-stage bootloader, in which the first bootloader points to a second or subsequent bootloader.

After logging the boot record start timestamp to a file, the inventive system checks to see if a failed boot process has occurred (step 111) by making a determination if a bad boot record exists (step 113), indicating that the prior attempt at booting resulted in a failed attempt. The determination (step 113) is made by checking for last boot record end time times tamp in a boot record file. If the computer failed to boot properly, the pre-OS bootloader calls the Primary OS to boot immediately (step 115), and writes a special boot log to the Primary OS' file system (step 117).

If the determination if a bad boot record exists (step 113) is negative, then the system boots to a secondary OS for scanning (step 121). A malware scanning application is native to the secondary OS and is capable of determining whether an operating system or file system of an operating system is compromised by scanning selected files in the operating system in a manner similar to that of an antivirus program or other malware detection program. The secondary OS determines if the Primary OS is compromised (step 123) by scanning the Primary OS' file system or a portion of the Primary OS' file system, with reference to one or more malware datafiles and a directory index file. The Secondary OS will scan all or part of the primary OS file system for matches to files listed in the MDF—the Master Definition File. The MDF can be either files provided by the various datafiles defining threats provided by security software vendors, possibly including custom malware definition files provided especially for use by the inventive application. Alternatively, the MDF can be files which the inventive application will create in reference to the various datafiles defining threats provided by security software vendors, possibly including custom malware definition files provided especially for use by the inventive application. The malware datafile is either a definition file used by the user's anti-malware programs, such as antivirus programs, or a file derived from the definition file.

In performing the scanning of the Primary OS' file system (step 123) and determination of whether the Primary OS is compromised (step 125), the determination is made by performing a file scan with the malware detection program operating under the secondary OS. The malware detection program will open the appropriate file systems and look for various conditions (which may change/evolve over time) per item in the datafile. The malware detection program will also look for any items which are detected to see if it should then remediate via removal or through a file conversion (or “file wrapping”) procedure. The scanning of the Primary OS' file system (step 123) results in a determination of whether the Primary OS is compromised (step 125).

If the Primary OS is compromised as determined in step 125, the process proceeds to a security layer application (step 131); otherwise, the process calls the Primary OS to load (step 133). If multiple operating systems are offered to the user, this selection can be made prior to the inventive secondary bootloader being called (step 107) or after the determination of whether the Primary OS is compromised (step 125).

In either case the inventive scanning application native to the secondary OS for scanning depends on the user having set of malware definitions resident on the computer. If these definitions are inaccessible, then it is possible to use the scanning application native to the secondary OS for scanning to retrieve a set of definitions, but this requires that the scanning application native to the secondary OS for scanning obtain an appropriate connection such as an Internet connection. The directory index file provides the scanning application native to the secondary OS for scanning with directions as to which part of the directory to scan and which files to scan, in a manner similar to a configuration file for a malware scanning program native to a scanned OS. The malware datafiles and directory index file may be combined as a single file, or may have separate components. In the event that multiple malware programs are necessary, such as if the user's antivirus program ignores spyware, then multiple malware datafiles may be used in either separate scans or in a combined scan.

The file conversion or “file wrapping” procedure is a conversion of the file determined to be compromised by disabling the file's function in some manner. Examples of file conversion are file data encryption, compression, through a method of fragmenting the file into multiple part, or by “munging” the file to alter a characteristic necessary for the file to be executed. In a simple form, changing a file name or extension so that the file is no longer recognized as a thread dependency is sufficient.

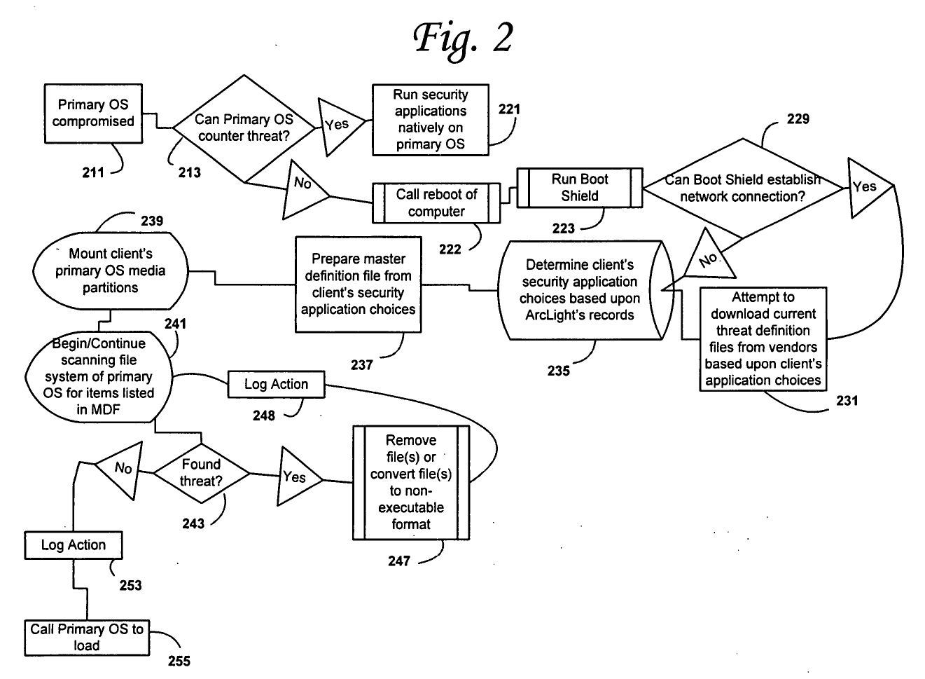

FIG. 2 is a flow chart depicting the overall operation of the invention. After an initial BIOS boot, the computer's primary bootloader directs bootloader execution to the inventive bootloader. In response to a determination to proceed to have the system boot to the inventive scanning application native to the secondary OS for scanning (step 121, FIG. 1), the system boots the scanning application native to the secondary OS for scanning (step 211). The pre-OS functions dictates that other methods have determined in step 211 that the Primary OS is compromised and can counter threat (step 213) on its own. This can be determined by running any security components currently installed on the Primary OS and seeing if all threats can be countered without further methods. If YES, allow security components currently installed on the Primary OS to counter threat (step 221). The inventive system is run on the user's local computer media, and will therefore have access to other security software installed on the user's primary operating system. If it is determined that the Primary OS may be unable to counter the threat (step 213), the inventive program will call a reboot of the computer (step 222), so that the malware removal process will then be instantiated by the reboot of the computer which will boot into a bootloader. The bootloader will boot into the inventive custom operating system (step 223) to complete needed processes before booting into the user's primary operating system(s).

When the inventive process has instantiated the boot into its custom operating system, it will attempt to perform a storage media mount of the user's primary operating system file system (part of step 223). The inventive process will then attempt to establish a TCP/IP, or other, network connection (step 229). If network connection can be established, the inventive process may attempt to communicate with external server(s) to receive any needed updates for functionality (step 231), including any execution patches and changes to security threat definitions. Following this, he inventive process will determine (step 235) which security software applications have been installed on the user's Primary OS based upon records stored on external server, files located on the inventive custom operating system or files located on the user's primary operating system. The inventive process will then configure and prepare a master list of threat definitions (MDF) into a file located on the inventive custom operating system (steps 237, 239) for scanning methods to use in its scanning and remediation process. The inventive process will scan through the previously mounted storage media for threats based upon the MDF file or files (step 243). If threat is located during scan the inventive process will remediate, or counter, threat via removal or conversion of each affected file (step 247). Examples of file conversion are file data encryption, compression or through a method of fragmenting the file into multiple parts or any other action which will either enable removal of the file by the Primary OS' software or will disable the threat. Any actions taken may be logged (step 248) on inventive custom operating system file system, user's primary operating system file system or on upstream server(s). When the scanning and remediation process has completed, finishing action(s) will be logged (step 253) and user's computer media will be booted out of inventive custom operating system and into the user's primary operating system, or other operating system, via the inventive bootloader (step 255).

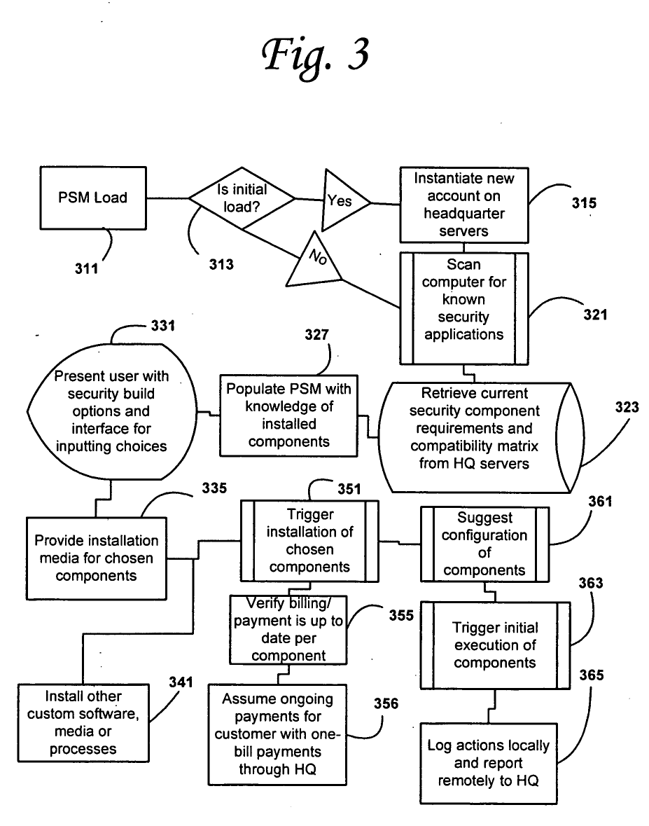

FIG. 3 is a flow chart 300 depicting a response to a threat detected in accordance with the present invention. According to the present invention, a bootloader is launched to initiate a computer file scan prior to launching a computer's primary or general operating system. The computer file scan can be a security scan or any other scan desired. The inventive process, being software, runs or is called to run or execute (step 311). The inventive process can be software installed on the user's machine or can be a software application accessible via a network, such as a web application.

When run, the inventive process will determine (step 313) if this the first run-time of the inventive process for this computer based upon matching records on upstream servers and/or log files on local digital storage media. If this is the first run-time of the inventive process for this computer, it will initiate (step 315) a process to create a account on upstream server for customer management and finalize any configurations needed to run the inventive process. The user may be prompted for additional personal or general information needed. If this is not the first run-time of the inventive process for this computer, or a new account for the user has just been initiated, the inventive process will scan, or audit, client computer for existing, installed security applications (step 321). The inventive process will further attempt to determine status of any security applications on the client computer, such as licensing status or other rights management status.

The inventive process will retrieve (step 323) current requirements for known security applications from upstream server(s) and will build a security application compatibility matrix (step 327) which will allow and disallow combinations of security applications based upon research and quality control of how they perform in conjunction to each other and to other variables that are deemed important. The inventive process will provide locally running instance of PSM with the prepared information, such as the compatibility matrix, from earlier step.

The user will then be presented with an interface (step 331) for inputting options and choices pertaining to security applications that they may choose to run on their computer media. Following some or al of these choices being made, the inventive process will provide means by which the user may install the chosen security software (step 335), be it installation media, instructions and/or hyperlinks to installation media. If required, the inventive process will initiate (step 341) the installation of additional software components or the instantiation of other processes as deemed necessary by the inventive process. The inventive process will attempt to call for the installation of the user's chosen security applications (step 351). The inventive process will then attempt to verify that billing and licensing is current and proper for all known, installed security applications. The inventive process will prompt the user to allow the inventive process to handle ongoing payments (step 355) for the chosen security software in a collective, one-point billing method (step 356) for user to better ensure that all applications continue to run as prescribed by the product manufacturer. The inventive process will attempt to provide (step 361) educated configuration suggestions for installed security applications, or when possible, prompt user with option to allow the inventive process to automatically configure the installed security application(s) for the user. The inventive process may attempt to call an initial run of the installed security applications on the computer media (step 363). The inventive process will log (step 365) some or all actions it has taken on local digital storage media and on upstream servers.

It is understood that various functions of the inventive process can be used for functions other than removal of malware or security threats during initial boot. For example, the present invention can be used to implement alternative operational functions of the client computer or can maintain rights management for software unrelated to security applications. The ability to maintain status of programs through an operating system other than the Primary OS also provides a degree of security by using a separate operating system to provide modifications to the Primary OS.

The secondary operating system can be provided in any convenient media, provided that the computer can be configured to boot to the secondary operating system. In one form, the secondary operating system can be resident on a partitioned hard drive or as a separately bootable operating system on the hard drive. Alternatively, the secondary operating system can be provided in the form of separate drive media such as a removable disk. It is also possible to launch the secondary operating system through a network by use of network booting techniques. In another alternative, the secondary operating system can function as a peripheral device, launched through a peripheral port such as a USB port or another type of port. As such, the secondary operating system can be configured as hardware, such as a USB dongle, or can be integrated into the computer's motherboard.

Those skilled in the art will appreciate that the various illustrative logical blocks, modules, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, microprocessor, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a microprocessor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, one or more elements can be rearranged and/or combined, or additional elements may be added. Thus, the present invention is not intended to be limited to the embodiments shown herein but is to be accorded the widest scope consistent with the principles and novel features disclosed herein.

1. A method for operating a computer providing preliminary data screening prior to booting the computer through an operating system, the method comprising:
using a primary operating system to provide a datafile for extraction of data for scanning;
responding to a computer boot initiation by loading a bootloader;
using the bootloader to boot a secondary operating system for scanning;
using the secondary operating system for scanning to initiate a scanning operation by opening the datafile of data for scanning and scanning predetermined files on the primary operating system;
using the secondary operating system for scanning to determine a scanned status of the primary operating system; and
responding to the scanned status of the primary operating system and calling the primary operating system to load.

2. The method of claim 1, further comprising:
determining which, if any, of the files on the primary operating system compromise the operation of the primary operating system; and
using the secondary operating system for providing remediation of the files determined to compromise the primary operating system.

3. The method of claim 2, wherein the remediation includes at least one of removing the threat, placing the primary operating system in a condition to remove the threat by modifying a program function deemed to cause the threat so as to permit a process running under the primary operating system to remove the threat, causing the threat to remain inactive in order to permit the a process running under the primary operating system to remove the threat, and converting the threat to a non-executable format.

4. The method of claim 2, wherein the remediation includes obtaining software to enable the primary software or a process running under the primary operating system to remove the threat.

5. The method of claim 1, comprising loading an initial operating system other than the primary operation system as the secondary operating system, and using a process running under the secondary operating system to obtain the software to enable the primary software or process running the primary operating system through a network connection.

6. The method of claim 1, comprising in the event of the primary operating system unable to counter the undesired software function, flagging at least one of the occurrence of an acceptable or unacceptable condition, and in response to a determination of the primary operating system as unable to counter the undesired software function by effecting a reboot, wherein the reboot directs the computer to launch the secondary operating system to perform the remediation of the undesired software function.

7. The method of claim 1, further comprising:
determining which, if any, of the files on the primary operating system compromise the operation of the primary operating system, said determination established by a failed attempt within the primary operating system to eliminate the compromise of the primary operating system; and
using the secondary operating system for providing remediation of the files determined to compromise the primary operating system.

8. The method of claim 1, wherein the responding to the scanned status of the primary operating system includes using the secondary operating system for scanning to provide a desired configuration for the primary operating system prior to calling the primary operating system to load.

9. The method of claim 1, wherein the responding to the scanned status of the primary operating system includes using the secondary operating system for scanning to provide a desired configuration for the primary operating system prior to calling the primary operating system to load, and in the event of an inability to provide a suitable configuration of the primary operating system, using the secondary operating system for scanning to install a suitable configuration of the primary operating system.

10. A method of providing a computer with an ability to circumvent compromised operational instructions, the method comprising:
determining the existence of an undesired software function operable under the computer's primary operating system;
determining an ability of the primary operating system to counter the undesired software function;
in the event of the primary operating system unable to counter the undesired software function, booting a secondary operating system, and using the secondary operating system to remediate the undesired software function; and
calling the primary operating system subsequent to the remediation.

11. The method of claim 10, wherein the remediation includes at least one of removing the threat, placing the primary operating system in a condition to remove the threat by modifying a program function deemed to cause the threat so as to permit a process running under the primary operating system to remove the threat, causing the threat to remain inactive in order to permit the a process running under the primary operating system to remove the threat, and converting the threat to a non-executable format.

12. The method of claim 10, wherein the remediation includes obtaining software to enable the primary software or a process running under the primary operating system to remove the threat.

13. The method of claim 12, comprising loading an initial operating system other than the primary operation system as the secondary operating system, and using a process running under the secondary operating system to obtain the software to enable the primary software or process running the primary operating system through a network connection.

14. The method of claim 10, comprising loading the initial operating system as the secondary operating system other than the primary operation system, and using a process running under the initial operating system to make the determination of the existence of the undesired software function operable under the computer's primary operating system.

15. The method of claim 10, comprising in the event of the primary operating system unable to counter the undesired software function, flagging at least one of the occurrence of an acceptable or unacceptable condition, and in response to a determination of the primary operating system as unable to counter the undesired software function by effecting a reboot, wherein the reboot directs the computer to launch the secondary operating system to perform the remediation of the undesired software function.

16. The method of claim 10, further comprising:
determining the status of malware definitions by scanning the computer for known security applications; and
providing a format of files suitable for said using the secondary operating system to remediate the undesired software function, based on the malware definitions by configuring one of the malware definitions or a program running under the secondary operating system to permit using the secondary operating system to remediate the undesired software function.

17. The method of claim 10, further comprising:
determining the status of malware definitions by scanning the computer for known security applications; and
retrieving from a network connection, at least one component to enable the secondary operating system to remediate the undesired software function.

18. Apparatus for providing a computer with an ability to circumvent compromised operational instructions comprising media containing operating instructions on storage media for performing the method of claim 10.

19. A program storage device readable by a machine tangibly embodying a program of instruction executable by the machine to perform method steps for providing preliminary data screening prior to booting the computer through an operating system, the method steps comprising:
determining the existence of an undesired software function operable under the computer's primary operating system;
determining an ability of the primary operating system to counter the undesired software function;
in the event of the primary operating system unable to counter the undesired software function, booting a secondary operating system, and using the secondary operating system to remediate the undesired software function; and
calling the primary operating system subsequent to the remediation.
